(19) United States
(12) Patent Application Publication
(10) Pub. No.: US 2017/0361880 A1
(43) Pub. Date: Dec. 21, 2017

(54) Aerodynamic Fairing Assembly for Tractor-Trailers

(71) Applicant: R-N-R International, Inc., Bristol, IN (US)

(72) Inventor: Stewart E. Gardner, Bristol, IN (US)

(73) Assignee: R-N-R International, Inc., Bristol, IN (US)

(21) Appl. No.: 15/187,597

(22) Filed: Jun. 20, 2016

(51) Int. Cl. B62D 35/00

(52) U.S. Cl. CPC B62D 35/001

(57) ABSTRACT

The aerodynamic fairing assembly attaches to the existing hardware of the swinging doors of conventional trailers to improve the aerodynamics. The fairing assembly includes left and right folding fairing panels that mount to the existing door hinges and two sets of lock arms that mount to the existing bar lock mechanism of a conventional box style trailer. The folding fairing panels manually fold between stowed and deployed positions.

This invention relates to an aerodynamic foil and drag reduction apparatus for tractor trailer doors.

### BACKGROUND AND SUMMARY OF THE INVENTION

The terms “Semi tractor trailers” or simply “tractor-trailers” commonly refer to the combination of a tractor truck and one or more semi-trailers used for over road transportation of goods and materials. Aerodynamic drag is a major contributor to fuel consumption in tractor-trailer commerce. Aerodynamic improvements can contribute to fuel savings and provide significant cost reduction.

A variety of fairing systems have been developed for the rear of trailers to improve trailer aerodynamics. Fixed air foils have been mounted to the rear doors of trailers, as well as, beneath the trailer deck to provide some degree of aerodynamic improvement. Fixed fairing extending from the rear of the trailers are generally impractical because they interfere with the movement of the doors when backed into the limited spaced of a loading dock. Other folding or collapsible fairing have been developed to mount to the trailer's rear doors. but such fairing systems have met limited success due to their mechanical complexity, functionality, reliability and cost.

The aerodynamic fairing assembly of this invention provides a convenient and cost effective manually deployed airfoil structure that improves trailer aerodynamics. The fairing assembly attaches to the existing hardware of the swinging doors of conventional trailers to improve the aerodynamics. The fairing assembly includes left and right folding fairing panels that mount to the existing door hinges and two sets of lock arms that mounts to the existing bar lock mechanism of a conventional box style trailer. The folding fairing panels manually fold between stowed and deployed positions. The folding panels include a rectangular panel frame, a rectangular support frame pivotally connected to the panel frame, and a cover panel affixed to the panel frame. The folding panels are pivotally mounted directly to the existing door hinge plates using separate panel hinges. The lock arms are mounted to the lock shafts of the bar lock mechanism used to hold the trailer doors closed. The lock arms move with the rotation lock bar to capture and hold the folding panels in the deployed position and stowed position.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective of an exemplary embodiment of the aerodynamic fairing assembly of this invention mounted to a conventional box style trailer in the deployed position;

FIG. 2 is a perspective of the fairing assembly of FIG. 1 shown in the stowed position;

FIG. 3 is a rear facing view of the fairing assembly of FIG. 1 shown in the deployed position;

FIG. 4 is a rear facing view of the fairing assembly of FIG. 1 shown in the stowed position;

FIG. 5 is a rear facing view of the fairing assembly of FIG. 1 shown in the stowed position with portions cutaway;

FIG. 6 is a simplified top view of the of the fairing assembly of FIG. 1 shown in the stowed position;

FIG. 7 is a simplified top view of the fairing assembly of FIG. 1 shown in the deployed position;

FIG. 8 is a simplified side view of the of the fairing assembly of FIG. 1 shown in the stowed position;

FIG. 9 is a simplified top view of the of the fairing assembly of FIG. 1 shown in the stowed position;

FIG. 10 is an exploded view of a panel hinge used in the fairing assembly of FIG. 1;

FIG. 11 is a partial sectional view of a panel hinge used in the fairing assembly of FIG. 1;

FIG. 12 is an exploded view of a lock arm used in the fairing assembly of FIG. 1;

FIG. 13 is a partial perspective view of the lock arm used in the fairing assembly of FIG. 1 in the deployed position;

FIG. 14 is a partial perspective view of the lock arm used in the fairing assembly of FIG. 1 pivoted away from the support frame; and

FIG. 15 is a partial sectional view of the lock arm used in the fairing assembly of FIG. 1 in the deployed position.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

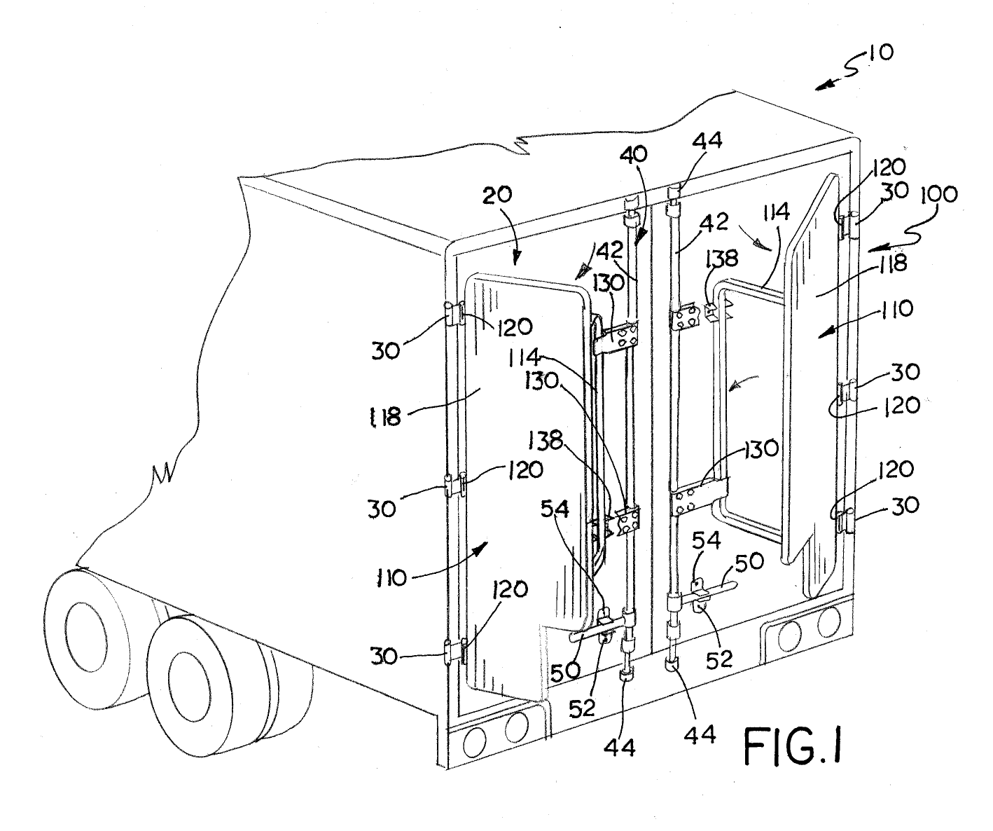

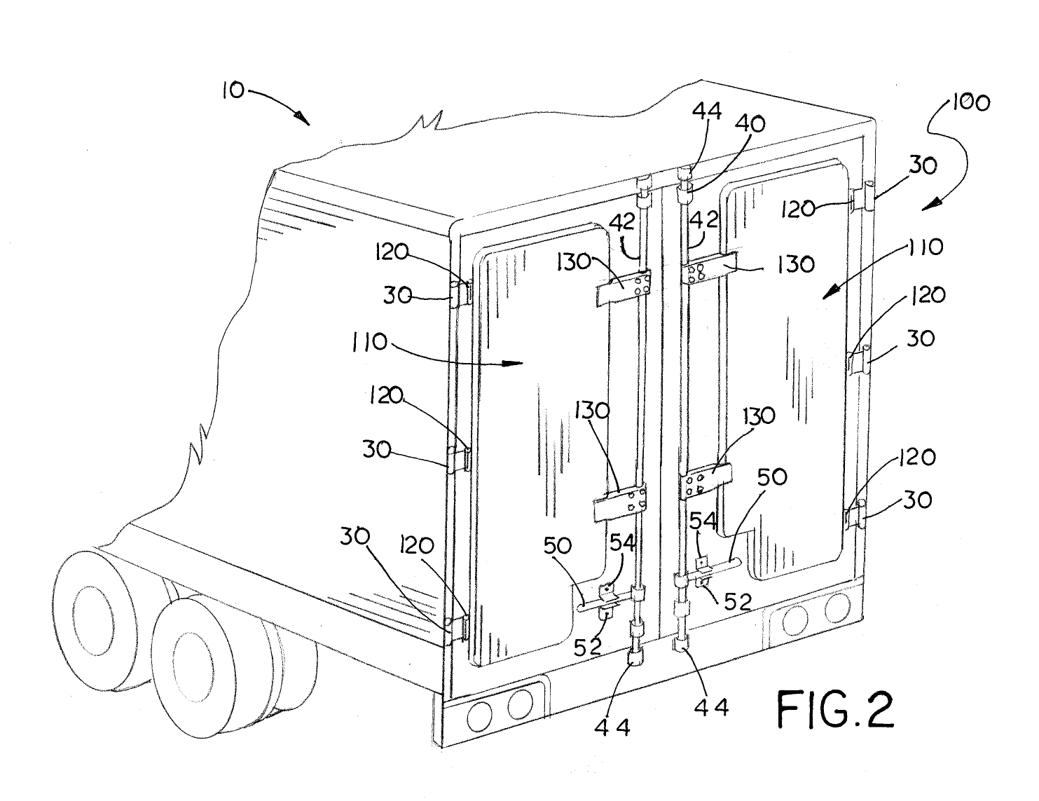

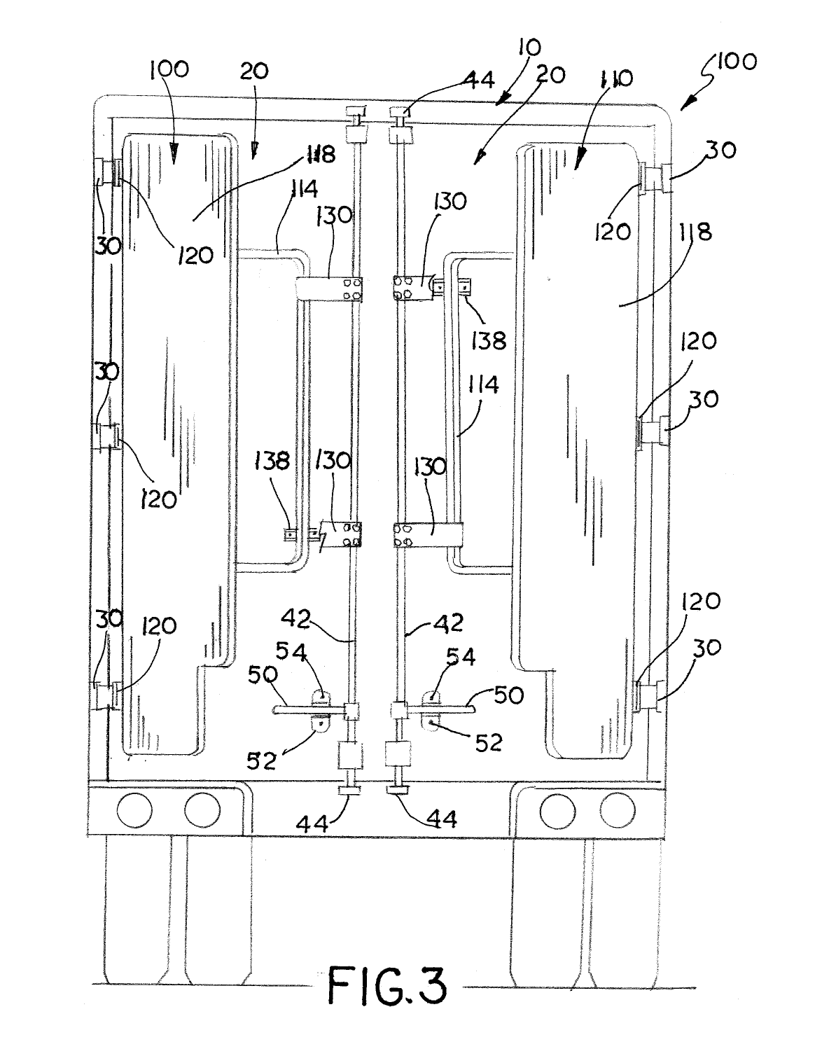

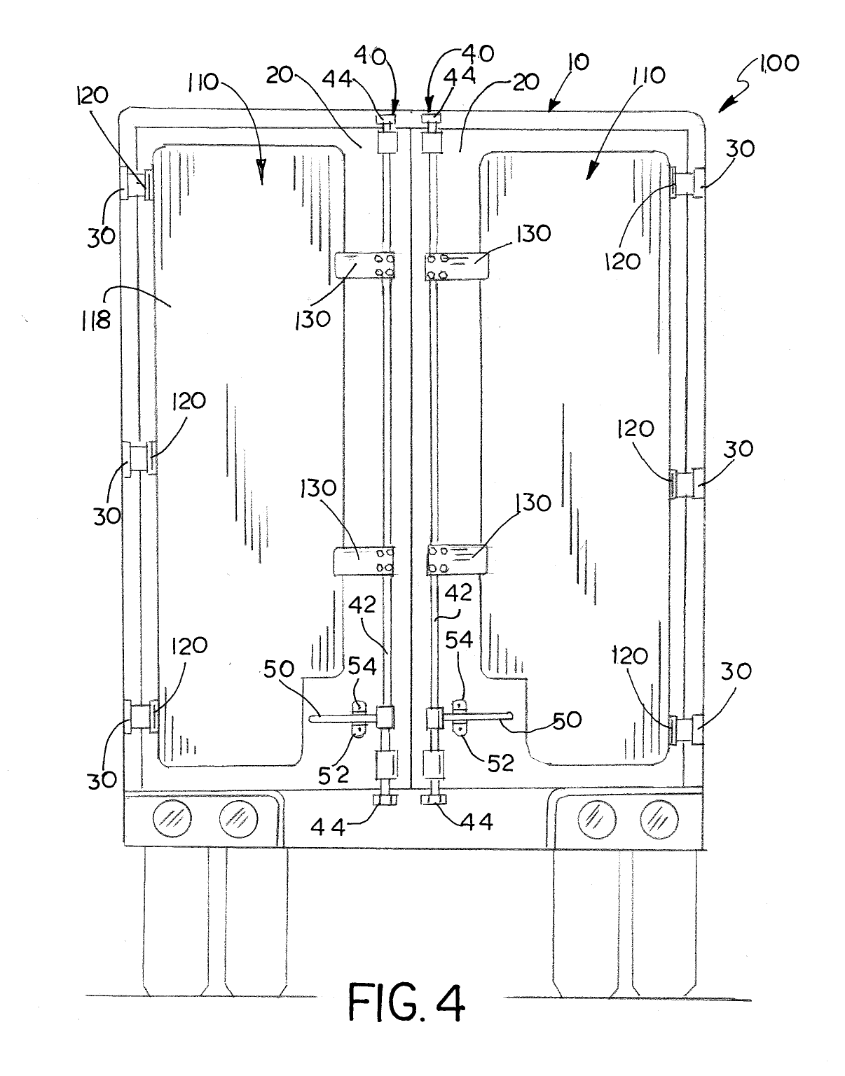

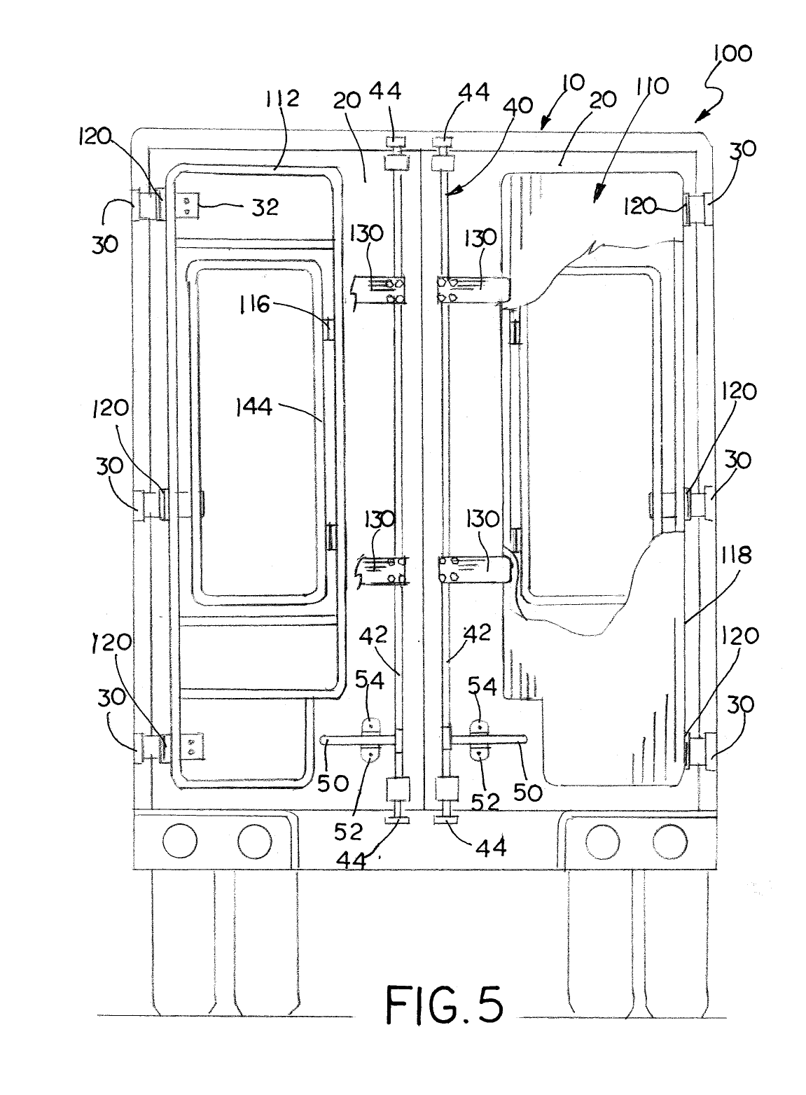

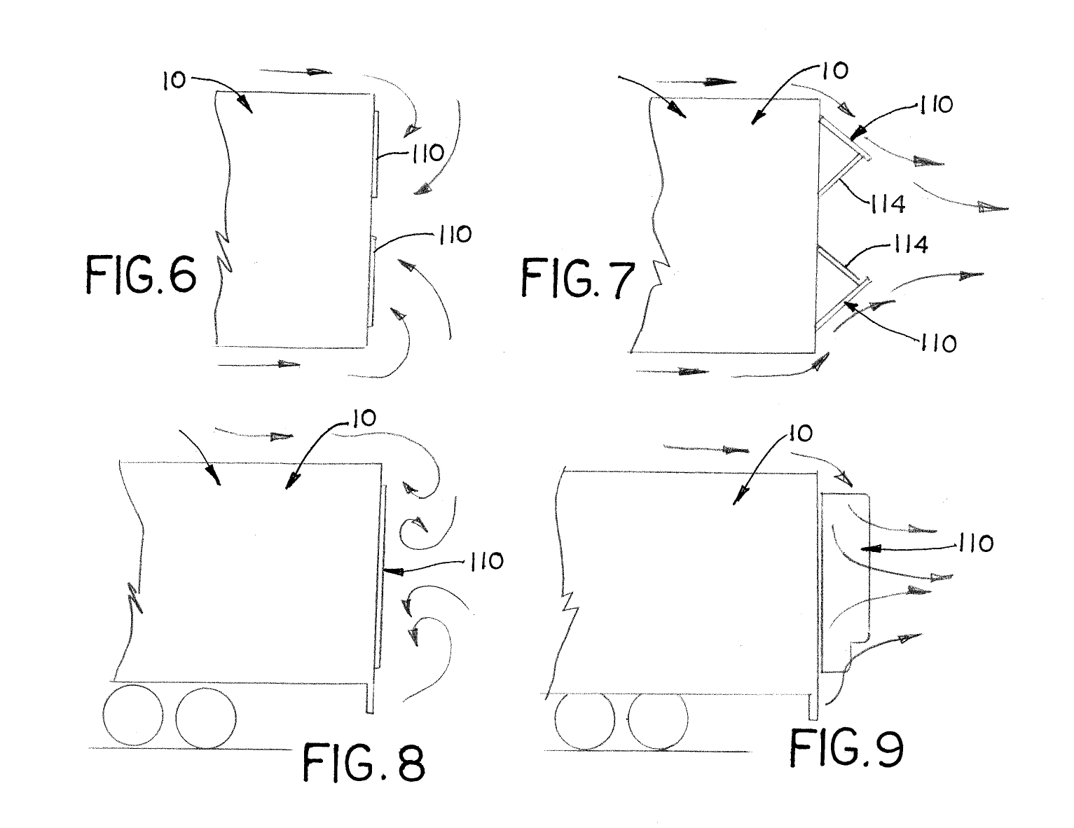

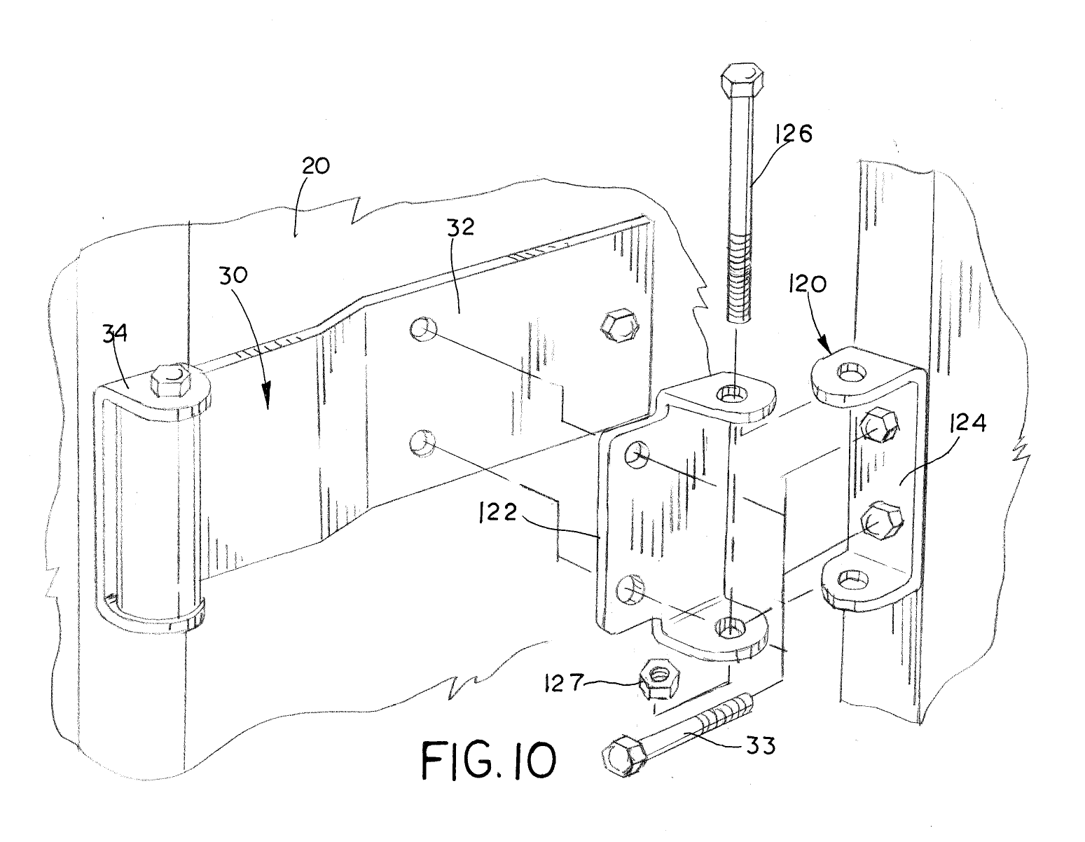

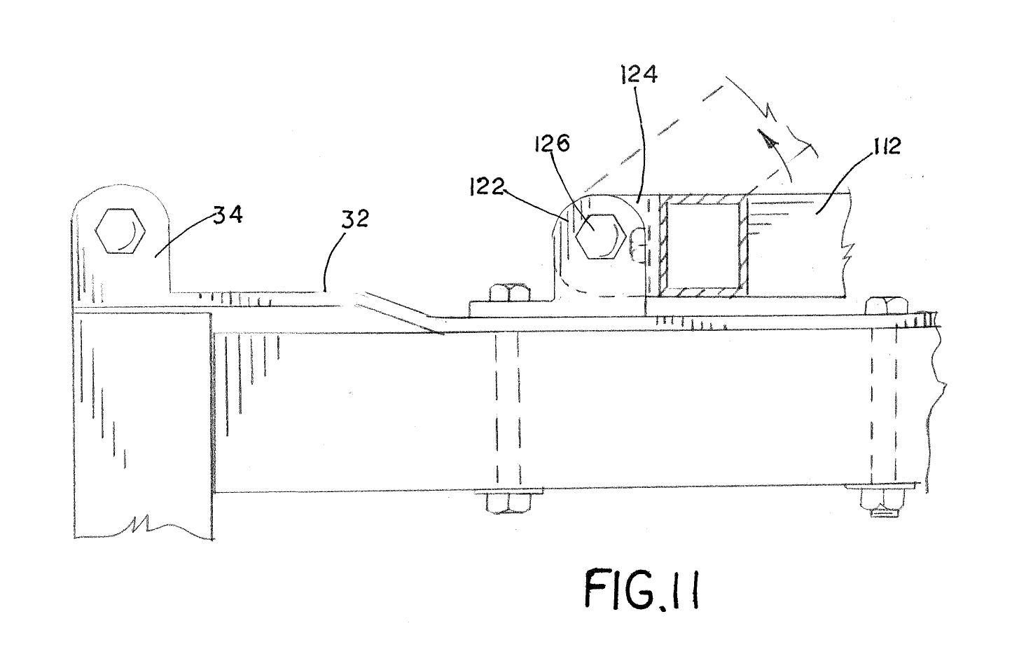

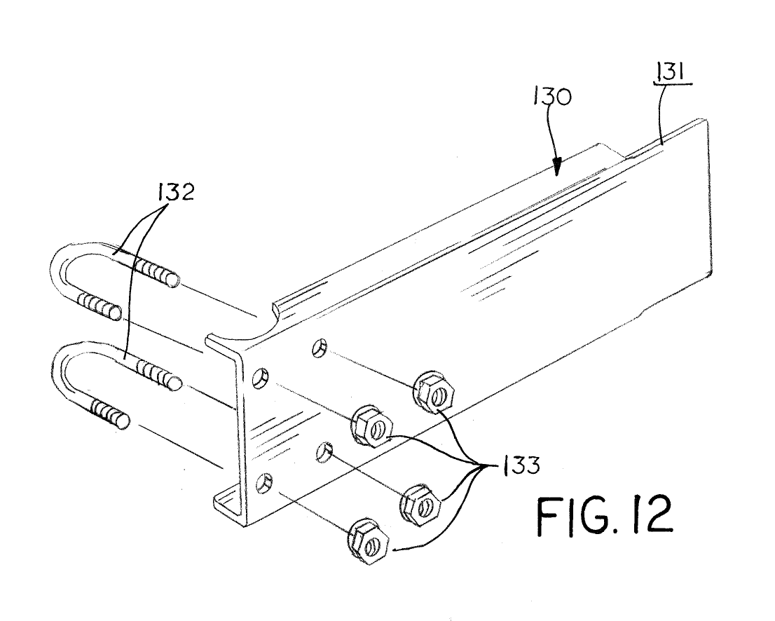

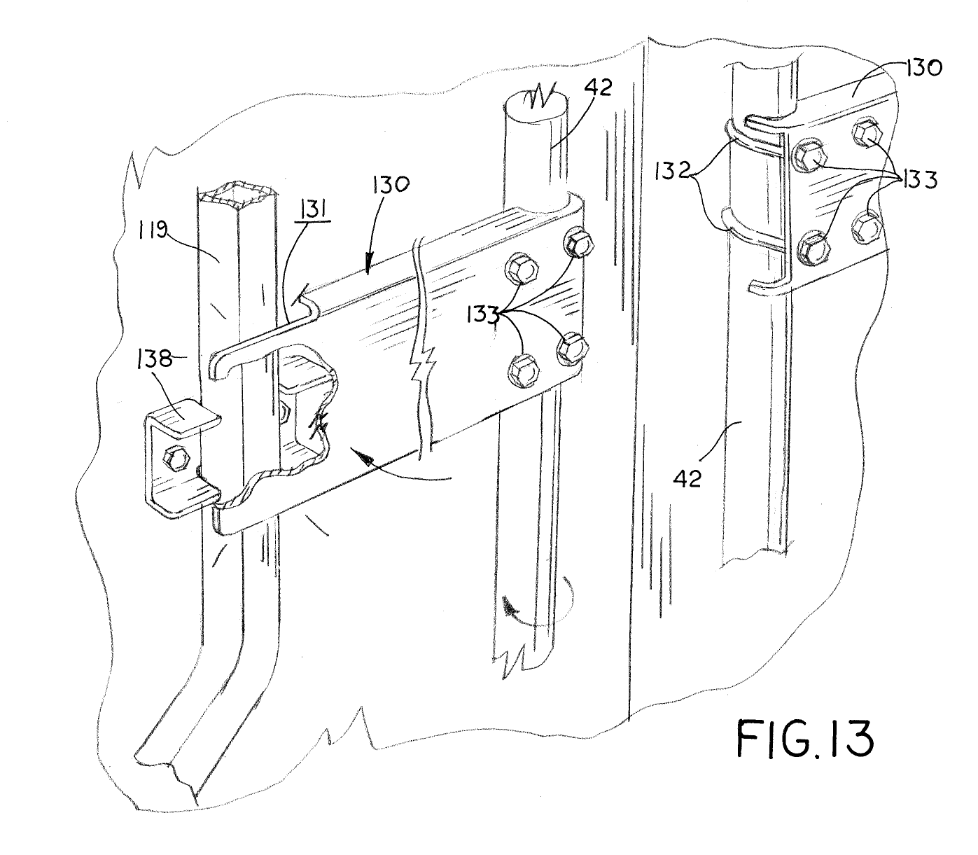

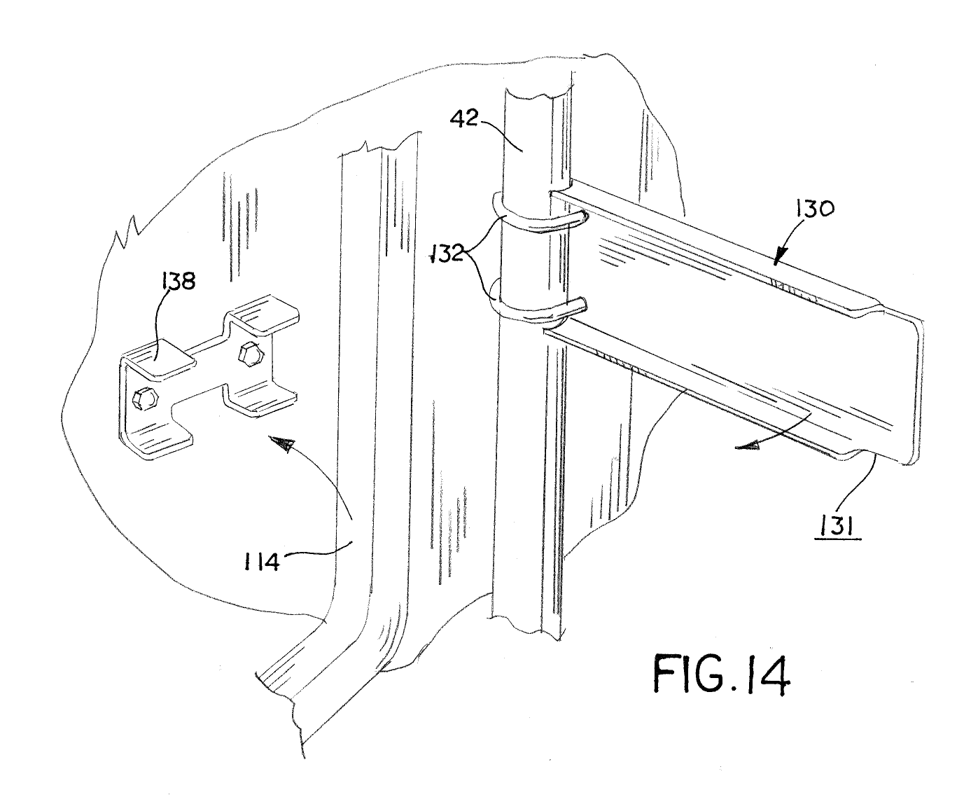

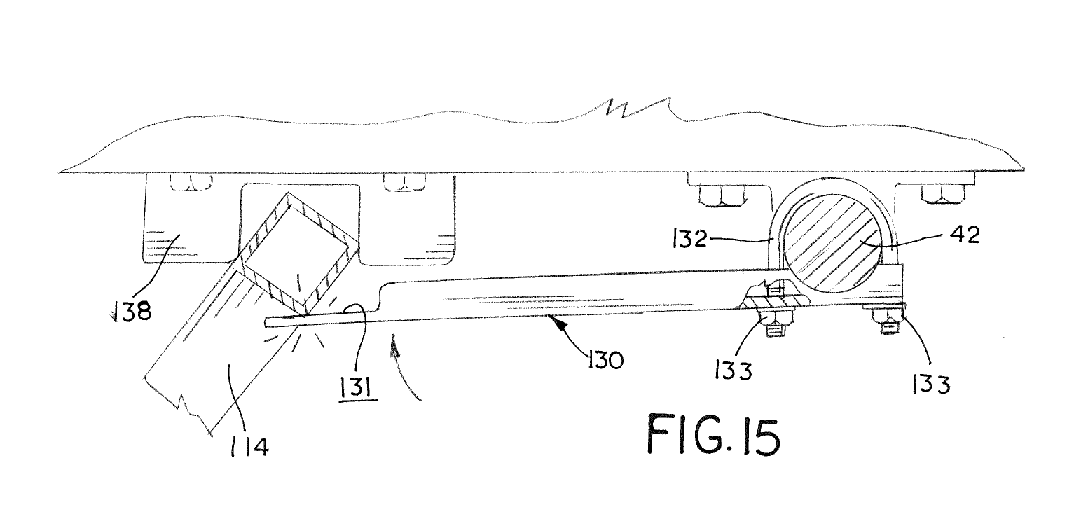

Referring now to the drawings, FIGS. 1-15 illustrate an exemplary embodiment of the aerodynamic fairing assembly of this invention, which is designated generally as reference numeral 100. As shown, aerodynamic fairing assembly 100 includes left and right folding fairing panels 110 that mount to the existing hinges and two sets of lock arms 130 that mounts to the bar lock mechanism of a conventional box style trailer. As shown in FIGS. 1-10, the folding fairing panels manually fold between a stowed position (FIGS. 2, 4, 6 and 8) where the panels lay flat against the trailer's swing rear cargo doors and a deployed position (FIGS. 1, 3, 7 and 9) where the panels extend angularly from the swinging doors. Lock arms 130 swing with the rotation of the bar lock mechanism to secure the folding panels 110 in their stowed and deployed positions.

For simplicity of illustration and explanation, the exemplary embodiment of the fairing assembles of this invention are illustrated in use on a typical box style semi trailers 10 with swinging rear cargo doors 20. Each of swinging trailer doors 20 is mounted to rear of trailer 10 by a pair of door hinges 30 and secured in the closed position by a conventional bar lock mechanism 40. Door hinges 30 includes hinge plates 32 bolted to the swing doors 20 and hinge brackets 34 bolted to the trailer sidewalls 12. Bar lock mechanism 40 is mounted to the outer face of each door 20 along the medial edge. Each bar lock mechanism 40 includes a long rotatable bar or pipe 42 and a pivoting handle 50 that rotates the bar to lock and unlock doors 20. Pipes 42 having cammed ends 44 which rotate to engage keepers mounted to the top and bottom edge of the trailer's rear opening. Handle 50 is captured in its locked position by a seal plate 52 and rotating seal pin 54 affixed to the outer face of doors 20.

As shown best in FIG. 5, folding panels 110 include a rectangular panel frame 112, a rectangular support frame 114 pivotally connected to the panel frame, and a cover panel 118 affixed to the panel frame. Panel and support frames 112 and 114 are typically constructed of metal tubing or other suitable materials. Support frame 114 is pivotally connected to panel frame 112 by a pair of frame hinges 116. Panel cover 118 is cut, stamped or otherwise formed from a sheet of sturdy, but light-weight material, such as aluminum alloy or composite material. A panel cover 118 is affixed over panel frame 112 using adhesives and screw fasteners. Panel cover 118 mounted to the panel frame provides airfoil surface for the fairing assembly when the panels are deployed. Support frame 114 pivots to supports the panel frame 112 when the folding panels 110 are in the deployed position and to nest within the support frame when the folding panels are in the stowed position. In addition when folding panels 110 are in the deployed position, support frames 114 seat within a keeper brackets 138 mounted to each swinging door 20.

As shown in FIGS. 5, 10 and 11, folding panels 110 are pivotally mounted to door hinge plates 32 by panel hinges 120. Each panel hinge 120 includes a pair of hinge brackets 122 and 124 connected by a pin bolt 126 and hex nut 127. Hinge bracket 122 is affixed to door hinge plate 32 using the existing bolts 33 that affix the door hinge plate to swinging door 20. Panel hinge bracket 124 is affixed to the edge of panel frame 112 by fasteners or bolts 125.

As shown in FIGS. 1, 2, and 12-15, a pair of spaced lock arms 130 is mounted to lock shaft 42. Each lock arm 130 is a length of metal U-channel that extends perpendicularly from lock shaft 42 and is affixed by a pair of U-bolts 132 and hex nuts 133. Affixing lock arms 130 to lock shaft 42 allows the lock arms to swing with the rotation of the lock shaft. The distal end of each lock arm 130 has a cutout 131, which is configured to capture support frame 114 in the deployed position and the side edge of panel cover 118 in the stowed position.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An aerodynamic fairing assembly for a tractor trailer, where the trailer includes a rear trailer door, a door hinge part for allowing the trailer door to pivot between a open position and a closed position, and a lock bar mechanism for securing the door in one of the closed position and having a rotating lock bar part mounted to the rear trailer door, the fairing assembly comprising:
a folding panel;
a panel hinge connecting the folding panel to the door hinge part so that the folding panel is movable between a deployed position where the folding panel extends rearward of the trailer door and a stowed position where the folding panel overlies the trailer door; and
a lock arm affixed to the lock bar part for pivotal movement between a locked position where the lock arm engages the folding panel to secure the folding panel in one of the deployed position and stowed position and an unlocked position where the lock arm is spaced from the folding panel.

2. The fairing assembly of claim 1 wherein the folding panel includes a panel frame and a support frame pivotally connected to the panel frame by a frame hinge for movement between a collapsed position where the support frame nests within the panel frame and an extended position where the support frame is pivoted away from the panel frame.

3. The fairing assembly of claim 2 wherein the lock arm engages the support frame in the locked position to hold the folding panel in the deployed position and engages the panel frame in the locked position to hold the folding panel in the stowed position.

4. The fairing assembly of claim 2 wherein the folding panel also includes a cover part affixed to the panel frame to overlie and cover the panel frame, thereby acting as an airfoil when the folding panel is in the deployed position.

5. The fairing assembly of claim 2 and a frame keeper mounted to the trailer door for receiving the support frame when the folding panel is in the deployed position.
